(19) United States
(12) Patent Application Publication
(10) Pub. No.: US 2010/0172367 A1
(43) Pub. Date: Jul. 8, 2010

(54) NETWORK BASED BANDWIDTH CONTROL IN IMS SYSTEMS

(75) Inventor: George Foti, Dollard des Ormeaux (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/350,641

(22) Filed: Jan. 8, 2009

(51) Int. Cl. H04L 12/28

(52) U.S. Cl. 370/431

(57) ABSTRACT

Systems and methods according to the present invention address this need and others by improving IMS service within the communications field. More particularly, systems and methods are described for controlling bandwidth.

### TECHNICAL FIELD

The present invention relates generally to telecommunications systems and improving service therein and, more particularly, to controlling bandwidth allocation in such systems.

### BACKGROUND

As the level of technology increases, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally, cellular phones and Wi-Fi have added a mobile element to communications. Similarly, in the entertainment industry, 30 years ago there was only one format for television and this format was transmitted over the air and received via antennas located at homes. This has evolved into both different standards of picture quality such as, standard definition TV (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also these services will be based on the technical capability to process and output more information, for example as seen in the improvements in the picture quality of programs viewed on televisions, and therefore it is expected that service delivery requirements will continue to rely on more bandwidth being available throughout the network including the “last mile” to the end user, e.g., the portion of a network from a digital subscriber line access multiplexer (DSLAM) to a residence.

Another related technology that impacts both the communications and entertainment industries is the Internet. The physical structures of the Internet and associated communication streams have also evolved to handle an increased flow of data. Servers have more memory than ever before, communications links exist that have a higher bandwidth than in the past, processors are faster and more capable and protocols exist to take advantage of these elements. As consumers' usage of the Internet grows, service companies have turned to the Internet (and other Internet Protocol (IP) networks) as a mechanism for providing traditional services. These multimedia services include IP television (IPTV), referring to systems or services that deliver television programs over a network using IP data packets), video on demand (VOD), voice over IP (VoIP), and other web related services received singly or bundled together.

To accommodate the new and different ways in which IP networks are being used to provide various services, new network architectures are being developed and standardized. For example, Internet Multimedia Subsystem (IMS) is an architectural framework utilized for delivering IP multimedia services to an end user. The IMS architecture has evolved into a service-independent topology which uses IP protocols, e.g., Session Initiation Protocol (SIP) signaling, to provide a convergence mechanism for disparate systems. In part, this is accomplished via the provision of a horizontal control layer which isolates the access network from the service layer. Among other things, IMS architectures may provide a useful platform for the rollout of IPTV systems and services.

One device associated with the provision of IPTV service within a residence is an Internet Protocol Television Terminal Function (ITF). ITFs allow users to create IMS sessions with an IMS network, after which they are able to access IPTV and other services (based upon, for example, their authorization/service agreements). Since each IMS session requires a certain amount of bandwidth over the “last mile”, multiple ITFs in use within a single residence will increase the need for more IMS bandwidth coming to the residence to support, for example, multiple, simultaneous IMS/IPTV sessions. These ITFs typically communicate through a home gateway to DSLAM, which in turn passes the communications on to other portions of the network as needed. As the number of ITFs and services increase, both from the perspective of the number of households serviced and the number of ITFs within a single household, the bandwidth associated with such service delivery is expected to be an area for consideration.

Accordingly, exemplary systems and methods for improving service by controlling bandwidth allocation are described below.

### SUMMARY

Systems and methods according to exemplary embodiments can improve service within the telecommunications field by controlling bandwidth allocation.

According to one exemplary embodiment a method for controlling bandwidth allocation in an Internet Multimedia Subsystem (IMS) communication system includes: evaluating IMS services currently being transmitted to a location; determining, based upon the IMS services currently being transmitted to the location, a bandwidth allocation for IMS sessions associated with the IMS services currently being transmitted to the location; and transmitting bandwidth allocation instructions, based upon the step of determining the bandwidth allocation for each of the services.

According to another exemplary embodiment a communications node for controlling bandwidth allocation in an Internet Multimedia Subsystem (IMS) communication system includes: a memory for storing information about IMS services currently being transmitted to a location; a processor for evaluating IMS services currently being transmitted to the location, wherein the processor further determines, based upon the IMS services currently being transmitted to the location, a bandwidth allocation for IMS sessions associated with the services currently being transmitted to the location; and a communications interface for transmitting bandwidth allocation instructions, based upon the step of determining the bandwidth allocation for each of the IMS services.

### BRIEF DESCRIPTION OF THE DRAWINGS

The accompanying drawings illustrate exemplary embodiments, wherein:

FIG. 1 shows a communications diagram from a household to an Internet Multimedia Subsystem (IMS) network;

FIG. 2(a) illustrates two Internet Protocol Television Terminal Functions (ITFs) receiving two different media streams according to exemplary embodiments;

FIG. 2(b) illustrates two ITFs receiving the same media stream and an associated reserved bandwidth according to exemplary embodiments;

FIG. 3 shows nodes associated with a wide area network (WAN) according to exemplary embodiments;

FIG. 4 shows a signaling diagram for controlling bandwidth according to exemplary embodiments;

FIG. 5 depicts a communication node according to exemplary embodiments; and

FIG. 6 shows a method flowchart for controlling bandwidth according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

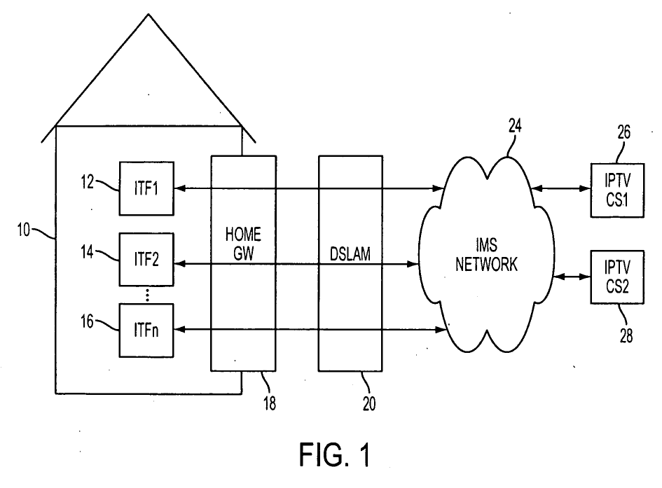

Systems and methods according to exemplary embodiments can improve service within the telecommunications field and more particularly to the control of bandwidth over the “last mile” to the end user, e.g., the portion of a network from a DSLAM to a residence. In order to provide some context for this discussion, an exemplary grouping of devices and communication links in which exemplary embodiments can be implemented will now be described with respect to FIG. 1.

FIG. 1 shows a household 10, which includes a number of Internet Protocol Television Terminal Functions (ITFs), ITF1 12, ITF2 14 up to ITFn 16 in communication with a home gateway (GW) 18. While the home gateway 18 is shown in FIG. 1 as a single device, it will be appreciated that the home gateway 18 could also be implemented as two separate devices, e.g., a gateway portion and a router portion, in communications with each other, with the control signaling typically passing through (and being selectively processed by) the gateway function portion and media signaling typically passing through (and being selectively processed by) the router function portion. Additionally, a digital subscriber line access multiplexer (DSLAM) 20 is shown connecting the devices within household 10 to an IMS network 24. In this example, each ITF 12, 14 and 16, when connecting to the IMS network 24, has its own IMS session, i.e., when using Telecommunications and Internet converged Services and Protocols for Advanced Networks (TISPAN) a separate IMS session is needed for each ITF 12, 14 and 16 operating within a single household 10. Policies are typically negotiated during the IMS session setups for each ITF 12, 14 and 16. Such policies include, for example, access policies which determine whether a corresponding user or ITF 12, 14, 16 can access a particular channel or media program. Upon completion of the IMS session setups, each ITF 12, 14 and 16 performs an IMS registration and receives user associated profiles. At this point users can request services, e.g., an Internet Protocol Television (IPTV) program, streaming audio and the like, from servers, such as, IPTV control server (CS)1 26 and IPTV CS2 28. Also, while not shown in FIG. 1, one or more networks can exist between DSLAM 20 and IMS network 24, through which their various communications can be forwarded.

As shown in FIG. 1, the home GW 18 is depicted as being disposed between the ITFs 12, 14 and 16 and the DSLAM 20, and can typically be considered to connect a local area network (LAN), e.g., the network of household 10, to a wide area network (WAN), e.g., IMS network 24 or another operator network. A DSLAM 20 will typically have multiple incoming physical DSLs, each of which connects the DSLAM 20 to a different individual household 10. In the upstream direction, e.g., from the household 10 towards the IMS network 24, a DSLAM 20 will take the received signal and split the data and voice portions to be forwarded to the appropriate carrier network (not shown) or voice switch (not shown), respectively. Additionally, DSLAM 20 typically contains multiple modems and is located either in a central office or in a remote location to service an area, e.g., a neighborhood.

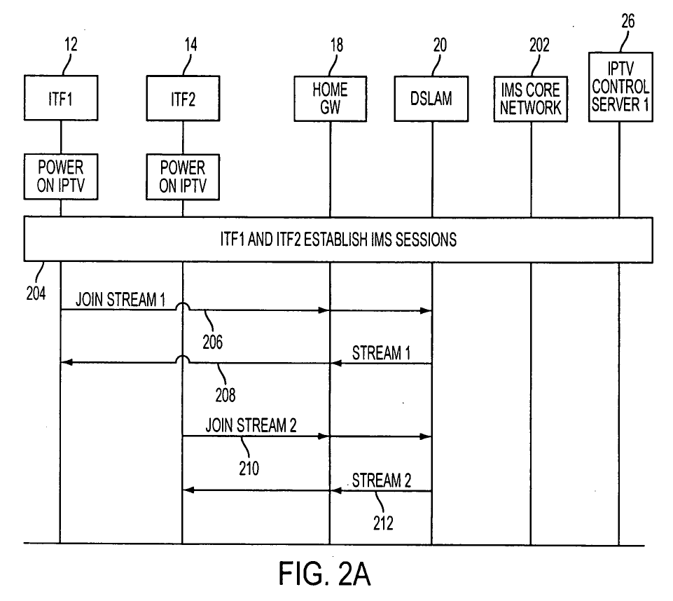

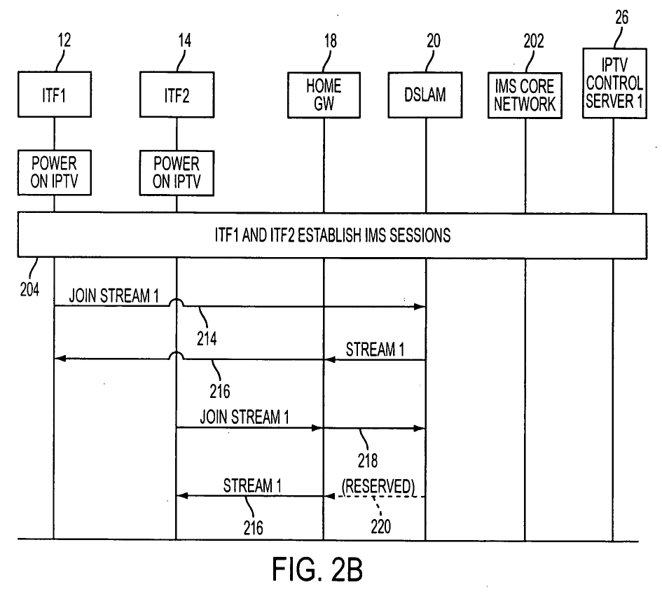

As described above, an IMS session is needed for each operating ITF 12, 14, 16 per household 10 based on current TISPAN standards. For these IMS sessions to be established there needs to be sufficient bandwidth available in the last mile of the network. As more ITFs 12, 14, 16 come online at a single household 10, more of the last mile bandwidth is used (or reserved) by the creation of corresponding IMS sessions. For example, consider the scenario as shown in FIG. 2(a) where two ITFs 12 and 14 are viewing different IPTV channels. Initially, ITF1 12 and ITF2 14 are powered on. ITF1 12 and ITF2 14 each then separately establish their own IMS session as shown in box 204. After the establishment of their respective IMS session, the ITFs 12 and 14 can access their allowed services. In this case, ITF1 12 transmits a JOIN stream1 request message 206 through the home GW 18 to the DSLAM 20. Upon receiving the requested service from a service provider, e.g., a media server (not shown), the DSLAM 20 forwards stream1 208 to the home GW 18 for forwarding to ITF1 12. ITF2 14 transmits a JOIN stream2 request message 210 through the home GW 18 to the DSLAM 20. Upon receiving the requested service from a service provider, the DSLAM 20 forwards stream 2 212 (which is different from stream1 208, e.g., the two ITFs 12 and 14 are outputting different IPTV programs or channels) to the home GW 18 for delivery to ITF2 14. As can be seen in FIG. 2(a), some portion of the last mile bandwidth is being used by the two different streams for two different IMS sessions.

By way of contrast, as will now be described with respect to FIG. 2(b), bandwidth allocation will now be shown for the case where two different ITFs 12 and 14 in a household request the same service. Initially, ITF1 12 and ITF2 14 are powered on. ITF1 12 and ITF2 14 each then separately establish their own IMS session as shown in box 204. After the establishment of their respective IMS session, the ITFs 12, 14 can access their allowed services. In this case, ITF1 12 transmits a JOIN stream1 request message 214 through the home GW 18 to the DSLAM 20. Upon receiving the requested service from a service provider, the DSLAM 20 forwards stream1 216 to the home GW 18 for forwarding to ITF1 12. ITF2 14 then transmits its own JOIN stream1 request message 218. At this point, the home GW 18, which is already receiving stream1 216, forwards stream1 216 to ITF2. However, since ITF2 14 has its own established IMS session, based on current TISPAN standards, there is reserved bandwidth 220 between the home GW 18 and the DSLAM 20 associated with ITF2 14 that is not being used, e.g. bandwidth of the size of stream1 216 is not used between the home GW 18 and DSLAM 20. This unused, reserved bandwidth 220 reduces the potential number of future ITF/IMS sessions which could otherwise be established at the household 10. Accordingly, exemplary methods and systems described below provide systems and methods for selectively allocating this reserved bandwidth for other purposes and/or selectively de-allocating this reserved bandwidth.

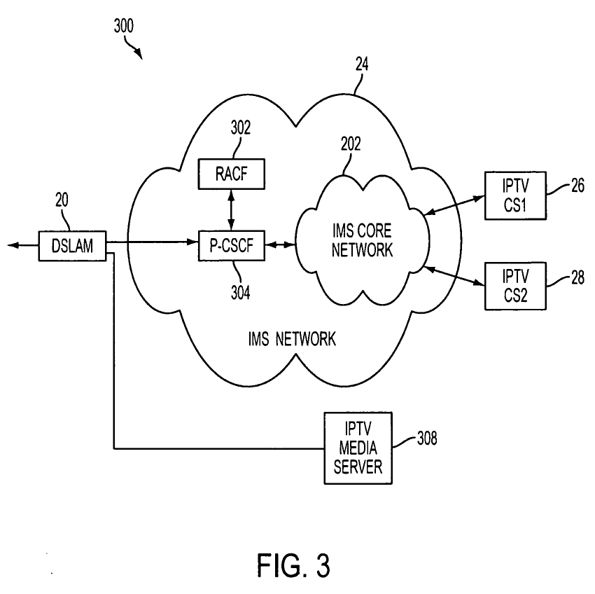

Prior to discussing these exemplary systems and methods, consider an exemplary wide area network (WAN) 300 portion of the network shown in FIG. 3. The WAN 300 includes DSLAM 20, an IMS network 24, IPTV CS1 26, IPTV CS2 28 and an IPTV media server 308. An exemplary IMS network 24 includes a proxy call session control function (P-CSCF) 304, a resource and admission control function (RACF) 302 and an IMS Core network 202 (which includes the nodes for IMS session setup, authorization and the like). The P-CSCF 304 represents a node where communications, typically control plane signaling, enter and leave the IMS network 24 for transmission through any intervening networks (not shown) to DSLAM 20 to be forwarded to the appropriate home GW 18. The RACF 302 is a functional element within the resource and admission control system (RACS). More specifically, the RACF 302 is the functional element which typically allocates and controls the resource requests, e.g., associated bandwidth of a service, made by a user device such as ITF1 12. More information regarding RACF 302 can be found in “Telecommunications and Internet converged Services and Protocols for Advanced Networking (TISPAN); Resource and Admission Control Sub-system (RACS); Functional Architecture, ETSI ES 282 003 V2.0.0 (2008-05)”. IPTV CS1 26 and IPTV CS2 28 represent the control servers for controlling requested services and typically deal with the related control plane signals. The IPTV media server 308 represents a server capable of streaming IPTV channels, e.g., stream1 208 and stream2 212, over the media plane.

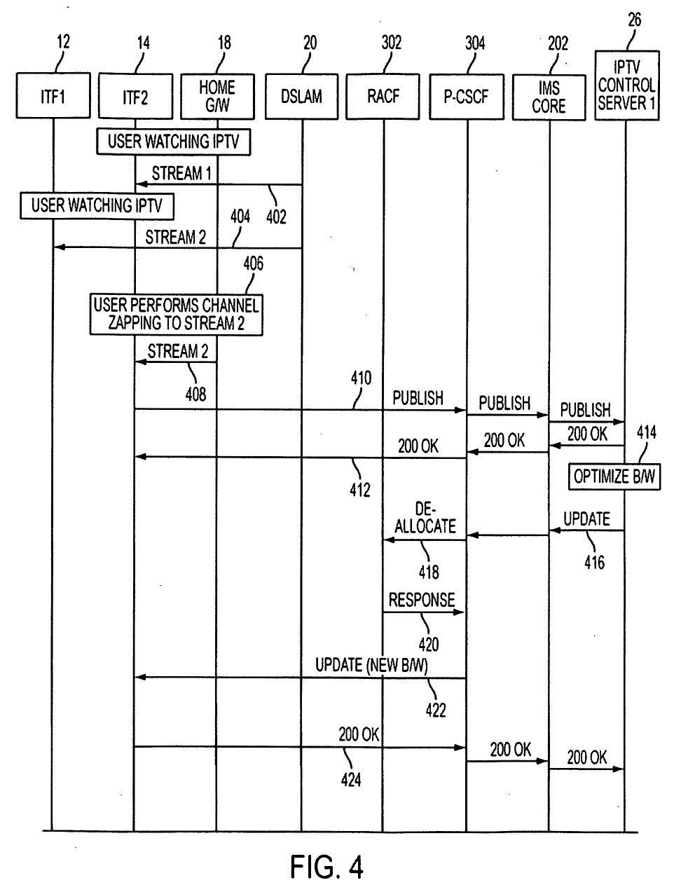

An IMS network 24 can have more nodes/functions than those shown with respect to FIG. 4, however, for simplicity, only certain nodes have been shown. More information generally regarding IMS networks can be found in the Third Generation Partnership Project (3GPP) Technical Specification (TS) 23.228 Version 8 dated March 2007. Using the above described communications frameworks, exemplary systems and methods are described below which can more efficiently use the bandwidth in the so-called last mile of a network.

According to exemplary embodiments, systems and methods allow for controlling the bandwidth used in the so-called last mile of a communications network. For example, assume that household 10 currently has five ITFs powered on, each with their own IMS session. Each ITF is receiving an IPTV channel, with three ITFs receiving IPTV channel 1, one ITF receiving IPTV channel 2 and one ITF receiving IPTV channel 3. Therefore, the bandwidth is being used or reserved for five IPTV channels on the communications link between the DSLAM 10 and the home GW 18. In this exemplary case, assume that all of the household's 10 last mile bandwidth which is available is being used by the five IMS sessions leaving no more bandwidth available for any more services. Accordingly, in this example, when a sixth ITF is turned on in household 10, there is no remaining bandwidth in the last mile and an IMS session will be denied to this sixth ITF. According to exemplary embodiments, the bandwidth that is being reserved in this portion of the network can be re-allocated (e.g., since two of the ITFs are receiving a duplicated stream from home GW 18, their unused, but reserved bandwidth may be temporary re-allocated) to the sixth ITF so that it can establish an IMS session with the network for the services it requires.

As described above, bandwidth in the last mile can be controlled. According to exemplary embodiments, the IPTV CS1 26 can be the decision making node which instructs other nodes, e.g., a RACF 302, regarding how bandwidth should be allocated in the last mile to a household 10. However, it will be appreciated that other nodes in the communications network could also (or alternatively) be responsible for this decision making process. For example, in the case where a household has multiple service providers, a communications node that coordinates those services could determine and transmit bandwidth control instructions for bandwidth allocation of those services provided by the multiple service providers. Also the communication node which is responsible for controlling bandwidth as discussed herein could keep track of all services currently being provided to each household, as well as other useful information, e.g., user policy information.

According to exemplary embodiments, the creation of instructions for bandwidth allocation in the last mile can be based upon a variety of information. This information can include maximum bandwidth available in the last mile, current bandwidth available in the last mile, current services being provided, policies currently stored in DSLAM 20, user policy information, quality of service requirements, user usage history, time of day and other user patterns. Additionally, this information can be selectively applied in any percentage increment from 0% to 100% inclusive. For example, if a stream going to household 10 is being received by multiple ITFs, then the reserved bandwidth used by the extra ITFs can be completely re-allocated for use by other ITFs. Alternatively, the reserved bandwidth could be fully maintained or some partial percentage of the reserved bandwidth could be de-allocated or re-allocated. This bandwidth allocation decision can be based on any or all of the information described above. Additionally, this bandwidth control (or optimization process) can be created by a statistical optimization (or algorithm(s)) based upon some, any, all or a combination of the known information regarding policies, habits and physical characteristics of the last mile portion of the network.

According to exemplary embodiments, a signaling diagram is shown in FIG. 4 for determining and delivering bandwidth control instructions based upon IPTV channel changing in household 10. Initially, ITF1 12 and ITF2 14 are powered up and have each performed an IMS session setup with the IMS Core network 202. ITF2 14 is receiving an IPTV channel as shown by stream1 402 and ITF1 12 is receiving a different IPTV channel as shown by stream2 404. Suppose that a user viewing stream1 402 on ITF2 14 decides to perform channel zapping (changing) 406 to stream2 as shown by the stream 408 going from the home GW 18 to ITF2 14. At this time, the full bandwidth for stream1 402 is being reserved for ITF2 14 over the last mile communication link between DSLAM 20 and home GW 18. After ITF2 14 has been receiving the new stream2 408 for a certain amount of time, e.g., approximately 10 seconds, showing no further current inclination to change channels, the ITF2 14 transmits a SIP PUBLISH 410 message indicating the current IPTV channel being viewed by ITF2 14, which is received by the IPTV CS1 26. The IPTV CS1 26 response is shown by a 200 OK message which is forwarded through the communications chain back to ITF2 14. IPTV CS1 26 then performs the bandwidth control (or optimization) process as described above and shown in step 414.

According to exemplary embodiments, the instructions (if any) that are generated from the bandwidth control process 414, are transmitted in a SIP UPDATE message 416 through the IMS Core network 202 to the P-CSCF 306. The P-CSCF 306 then updates the RACF 304 as shown by the de-allocate message 418 and the response message 420 from the RACF 304. The bandwidth instructions are forwarded to the ITF2 14 through the communications chain as SIP UPDATE message 422. Acknowledgement of these instructions by the ITF2 14 is shown by the 200 OK message(s) 424 which is ultimately received by the IPTV CS1 26.

Typically upon a change in the bandwidth allocated for an ITF 12, 14, 16, the P-CSCF 304 updates the policies in the DSLAM 20 to reflect the new policies. According to exemplary embodiments, in this case, the P-CSCF 304 will not perform such an update to the DSLAM 20 to avoid having the request being blocked. For example, if the ITF 12, 14, 16 decided to join a new channel the request will be blocked by the DSLAM 20 (since too much bandwidth would have been deallocated), if the P-CSCF 304 updated the DSLAM 20. Exemplary embodiments rely on the bandwidth optimization process to ensure, possibly through statistical methods, that there will be enough bandwidth available for the JOIN request to succeed even though the bandwidth optimization process deallocated the bandwidth for that ITF 12, 14, 16 earlier. This ensures that the JOIN request is not rejected by the DSLAM 20. Later, once the P-CSCF 304 is informed of the new channel it may perform a further UPDATE message to allocate more bandwidth for the ITF 12, 14, 16 again relying on the bandwidth optimization process.

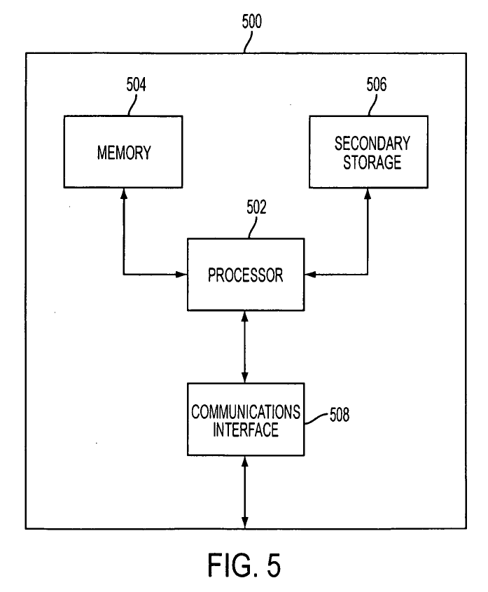

The exemplary embodiments described above provide methods and systems for controlling bandwidth over the last mile of a network. An exemplary communications node 500 which can be used, for example, to control bandwidth, will now be described with respect to FIG. 5. Communications node 500 can contain a processor 502 (or multiple processor cores), memory 504, one or more secondary storage devices 506 and a communications interface 508 to facilitate communications itself and the rest of the network(s). Processor 502 can also perform the function of creating instructions for controlling bandwidth by using the systems and methods described above. The additional function of an IPTV control server can also be provided by communication node 500.

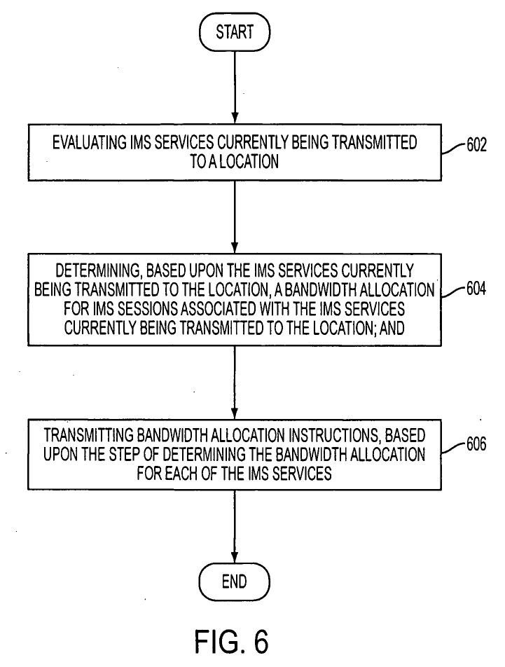

Utilizing the above-described exemplary systems according to exemplary embodiments, a method for controlling bandwidth is shown in the flowchart of FIG. 6. Initially a method for controlling bandwidth allocation in an Internet Multimedia Subsystem (IMS) communication system includes: evaluating IMS services currently being transmitted to the location in step 602; determining, based upon the services currently being transmitted to the location, a bandwidth allocation for IMS sessions associated with the IMS services currently being transmitted to the location in step 604; and transmitting bandwidth allocation instructions, based upon the step of determining the bandwidth allocation for each of the services in step 606.

The above-described exemplary embodiments are intended to be illustrative in all respects, rather than restrictive, of the present invention. All such variations and modifications are considered to be within the scope and spirit of the present invention as defined by the following claims. For example, an IMS network 24 will typically include more nodes but for simplicity only certain nodes have been shown. No element, act, or instruction used in the description of the present application should be construed as critical or essential to the invention unless explicitly described as such. Also, as used herein, the article “a” is intended to include one or more items.

What is claimed is:

1. A method for controlling bandwidth allocation in an Internet Multimedia Subsystem (IMS) communication system comprising:
evaluating IMS services currently being transmitted to a location;
determining, based upon said IMS services currently being transmitted to said location, a bandwidth allocation for IMS sessions associated with said IMS services currently being transmitted to said location; and
transmitting bandwidth allocation instructions, based upon said step of determining said bandwidth allocation for said IMS sessions.

2. The method of claim 1, wherein said step of determining said bandwidth allocation for IMS sessions associated with said IMS services currently being transmitted to said location further comprises:
selectively de-allocating bandwidth associated with at least one service which is being replicated to said location.

3. The method of claim 2, wherein the step of selectively de-allocating bandwidth associated with said at least one replicated IMS service to said location results in no redundant streams being transmitted to said location.

4. The method of claim 2, wherein said step of determining said bandwidth allocation for IMS sessions associated with said IMS services currently being transmitted to said location is further determined by information about IMS service usage associated with said location.

5. The method of claim 1, further comprising:
storing information about said IMS service usage associated with said location; and
receiving a message requesting an IMS service for said location.

6. The method of claim 5, wherein said information about IMS service usage associated with said location includes at least one of user policy information, user usage history, time of day and user patterns.

7. The method of claim 1, wherein said location includes a plurality of Internet Protocol Television (IPTV) Terminal Functions (ITFs).

8. The method of claim 1, wherein said IMS services include at least one of an IPTV channel and a streaming audio selection.

9. The method of claim 1, wherein said bandwidth allocation is for bandwidth between a digital subscriber line access multiplexer (DSLAM) and said location.

10. A communications node for controlling bandwidth allocation in an Internet Multimedia Subsystem (IMS) communication system comprising:
a memory for storing information about IMS services currently being transmitted to a location;
a processor for evaluating IMS services currently being transmitted to said location, wherein said processor further determines, based upon said IMS services currently being transmitted to said location, a bandwidth allocation for IMS sessions associated with said IMS services currently being transmitted to said location; and
a communications interface for transmitting bandwidth allocation instructions, based upon said step of determining said bandwidth allocation for each of said IMS services.

11. The communications node of claim 10, wherein said processor further determines bandwidth allocation for each IMS sessions associated with said IMS services currently being transmitted to said location by selectively de-allocating bandwidth associated with at least one IMS service which is being replicated to said location.

12. The communications node of claim 11, wherein selectively de-allocating bandwidth associated with at least one IMS service to said location results in no redundant streams being transmitted to said location.

13. The communications node of claim 11, wherein said processor further determines said bandwidth allocation for IMS sessions associated with said IMS services currently being transmitted to said location by using information about IMS service usage associated with said location.

14. The communications node of claim 10, wherein said memory further stores information about said IMS service usage associated with said location, and said communications interface further receives a message requesting a IMS service for said location.

15. The communications node of claim 14, wherein said information about IMS service usage associated with said location includes at least one of user policy information, user usage history, time of day and user patterns.

16. The communications node of claim 10, wherein said location includes a plurality of Internet Protocol Television (IPTV) Terminal Functions (ITFs).

17. The communications node of claim 10, wherein said IMS services include at least one of an IPTV channel and a streaming audio selection.

18. The communications node of claim 10, wherein said bandwidth allocation is for bandwidth between a digital subscriber line access multiplexer (DSLAM) and said location.

19. The communications node of claim 10, wherein said communications node is an Internet Protocol Television (IPTV) control server.
